(19) United States
(12) Patent Application Publication
(10) Pub. No.: US 2009/0303599 A1
(43) Pub. Date: Dec. 10, 2009

(54) General diffractive optics method for expanding an exit pupil

(75) Inventor: Tapani Levola, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 11/921,533

(22) PCT Filed: Jun. 3, 2005
(86) PCT No.: PCT/US05/19368

§ 371 Date: Jun. 22, 2009

(51) Int. Cl. G02B 27/44

(52) U.S. Cl. 359/567; 359/569

(57) ABSTRACT

This invention describes a general diffractive optics method that uses a plurality of diffractive elements on an optical substrate for expanding the exit pupil of a display of an electronic device for viewing. The method can be used for optical coupling in an optical device and it is characterized by extending of an exit pupil of an input optical beam in an output optical beam wherein the optical device comprises: an optical substrate and in-coupling, intermediate and out-coupling diffractive element disposed on the optical substrates, wherein periodic lines of the intermediate diffractive element comprise an angle ρ with periodic lines of the in-coupling and of the out-coupling diffractive elements, respectively. The system can support a broad range of rotation angles (e.g., 0<ρ<70°) and corresponding conical angles and remains geometrically accurate.

### TECHNICAL FIELD

The present invention relates generally to a display device and, more specifically, to a general diffractive optics method that uses a plurality of diffractive elements for expanding the exit pupil of a display for viewing.

### BACKGROUND ART

While it is a common practice to use a low-resolution liquid-crystal display (LCD) panel to display network information and text messages in a mobile device, it is preferred to use a high-resolution display to browse rich information content of text and images. A microdisplay-based system can provide full color pixels at 50-100 lines per mm. Such high-resolution is generally suitable for a virtual display. A virtual display typically consists of a microdisplay to provide an image and an optical arrangement for manipulating light emerging from the image in such a way that it is perceived as large as a direct view display panel. A virtual display can be monocular or binocular.

The size of the beam of light emerging from imaging optics toward the eye is called exit pupil. In a Near-Eye Display (NED), the exit pupil is typically of the order of 10 mm in diameter. Further enlarging the exit pupil makes using the virtual display significantly easier, because the device can be put at a distance from the eye. Thus, such a display no longer qualifies as an NED, for obvious reasons. Head-Up Displays are examples of the virtual display with a sufficiently large exit pupil.

PCT patent application WO 99/52002 “Holographic optical Devices” by Yaakov Amitai and Asher Friesem and U.S. Pat. No. 6,580,529 Holographic optical Devices” by Yaakov Amitai and Asher Friesem disclose a method of enlarging the exit pupil of a virtual display. The disclosed method uses three successive holographic optical elements (HOEs) to enlarge the exit pupil. In particular, the HOEs are diffractive grating elements arranged on a planar, light transmissive substrate 6, as shown in FIG. 1. As shown, light from an image source 2 is incident upon the first HOE, or H1, which is disposed on one side of the substrate 6. Light from H1, coupled to the substrate 6, is directed toward the second HOE, or H2, where the distribution of light is expanded in one direction. H2 also redirects the expanded light distribution to the third HOE, or H3, where the light distribution is further expanded in another direction. The holographic elements can be on any side of the substrate 6. H3 also redirects the expanded light distribution outward from the substrate surface on which H3 is disposed. The optical system, as shown in FIG. 1, operates as a beam-expanding device, which approximately maintains the general direction of the light beam. Such a device is also referred to as an exit pupil expander (EPE).

In an EPE, the energy of the exit beam relative to the input beam depends upon the coupling between adjacent optical elements. As the energy output of the image source is limited, it is desirable to achieve a high coupling efficiency between adjacent optical elements.

### DISCLOSURE OF THE INVENTION

The object of the present invention is to provide a general diffractive optics method that uses a plurality of diffractive elements on an optical substrate for expanding the exit pupil of a display of an electronic device for viewing.

According to a first aspect of the invention, an optical device, comprises: a substrate of optical material having a first surface and an opposing second surface; a first diffractive element disposed on the substrate for receiving an input optical beam defined by a wave-vector k and containing periodic lines with a period d; a second diffractive element disposed on the substrate in relationship with the first diffractive element and containing further periodic lines with a period d, wherein an angle between the periodic lines and the further periodic lines is 2ρ; and an intermediate diffractive element disposed on the substrate adjacent to the first and the second diffractive elements and containing still further periodic lines with the period d/2 cos ρ, wherein ρ is an angle between the periodic lines and the still further periodic lines, wherein at least part of the input optical beam is diffracted in the first diffractive element for providing a diffracted optical component to the intermediate diffractive element substantially within the first and second surfaces, and at least part of the diffracted optical component in the intermediate diffractive element is coupled to the second diffractive element substantially between the first and second surfaces so as to allow at least part of the coupled diffracted optical component to exit the substrate by diffraction in the second diffractive element thus providing an output optical beam defined by a further wave-vector k1 having exactly the same direction as the wave-vector k of the input optical beam.

According further to the first aspect of the invention, the optical device may be for extending of an exit pupil of the input optical beam by providing the output optical beam.

Further according to the first aspect of the invention, the diffracted optical component may be incident and subsequently diffracted to a first order on the intermediate diffraction element an uneven number of times before providing the at least part of the diffracted light component to the second diffraction element.

Still further according to the first aspect of the invention, the intermediate diffractive element may support only reflective zero and first order diffraction modes, or an index of refraction of the substrate may be given by n>λ/d, wherein λ is a wavelength of the input optical beam.

According yet further to the first aspect of the invention, a predetermined condition may be maintained, the condition is that a second or higher order modes may be unsupported by the intermediate diffractive element, or the condition may be expressed as

$$\sqrt{1 + 8 {cos}^{2} ρ} > \frac{nd}{λ} ,$$

wherein n is an index of refraction of the substrate, λ is a wavelength of the input optical beam. Further, ρ may be given by 0<ρ<70°.

According still further to the first aspect of the invention, another predetermined condition may be maintained, the condition is that transmission modes may be unsupported for the intermediate diffractive element, or the condition may be expressed as λ/d>1, wherein λ is a wavelength of the input optical beam.

According further still to the first aspect of the invention, the first diffractive element, the second diffractive element or the intermediate diffractive element may be disposed on the first surface or on the second surface.

According to a second aspect of the invention, a method for extending of an exit pupil of an input optical beam provided in an output optical beam, comprises the steps of: receiving an input optical beam defined by a wave-vector k at a first diffractive element containing periodic lines with a period d and disposed on a substrate of optical material having a first surface and an opposing second surface; diffracting at least part of the input optical beam in the first diffractive element for providing a diffracted optical component to an intermediate diffractive element substantially within the first and second surfaces; further diffracting the diffracted optical component by the an intermediate diffractive element; and coupling at least part of the further diffracted the diffracted optical component in the intermediate diffractive element to a second diffractive element substantially between the first and second surfaces so as to allow at least part of the coupled diffracted optical component to exit the substrate by diffraction in the second diffractive element thus providing an output optical beam defined by a further wave-vector k1 having exactly the same direction as the wave-vector k of the input optical beam, wherein the second diffractive element is disposed on the substrate in relationship with the first diffractive element and contains further periodic lines with a period d and wherein an angle between the periodic lines and the further periodic lines is 2ρ and the intermediate diffractive element is disposed adjacent to the first and the second diffractive elements and contains still further periodic lines with the period d/2 cos ρ, wherein ρ is an angle between the periodic lines and the still further periodic lines.

According further to the second aspect of the invention, the diffracted optical component may be incident and subsequently diffracted to a first order on the intermediate diffraction element an uneven number of times before the at least part of the diffracted light component is provided to the second diffraction element.

Further according to the second aspect of the invention, the intermediate diffractive element may support only zero and first order reflective modes, or an index of refraction of the substrate may be given by n>λ/d, wherein λ is a wavelength of the input optical beam.

Still further according to the second aspect of the invention, a predetermined condition may be maintained, the condition is that a second or higher order modes may be unsupported by the intermediate diffractive element, or the condition may be expressed as

$$\sqrt{1 + 8 {cos}^{2} ρ} > \frac{nd}{λ} ,$$

wherein n is an index of refraction of the substrate, λ is a wavelength of the input optical beam. Further, ρ may be given by 0<ρ<70°.

According yet further to the second aspect of the invention, another predetermined condition may be maintained, the condition is that transmission modes may be unsupported for the intermediate diffractive element, or the condition may be expressed as λ/d>1, wherein λ is a wavelength of the input optical beam.

According further still to the second aspect of the invention, the first diffractive element, the second diffractive element or the intermediate diffractive element may be disposed on the first surface or on the second surface.

According to a third aspect of the invention, an electronic device, comprising: —a data processing unit; —an optical engine operatively connected to the data processing unit for receiving image data from the data processing unit; —a display device operatively connected to the optical engine for forming an image based on the image data; and —an exit pupil expander comprising: a substrate of optical material having a first surface and an opposing second surface; a first diffractive element disposed on the substrate for receiving an input optical beam defined by a wave-vector k and containing periodic lines with a period d; a second diffractive element disposed on the substrate in relationship with the first diffractive element and containing further periodic lines with a period d, wherein an angle between the periodic lines and the further periodic lines is 2ρ; and an intermediate diffractive element disposed on the substrate adjacent to the first and the second diffractive elements and containing still further periodic lines with the period d/2 cos ρ, wherein ρ is an angle between the periodic lines and the still further periodic lines, wherein at least part of the input optical beam is diffracted in the first diffractive element for providing a diffracted optical component to the intermediate diffractive element substantially within the first and second surfaces, and at least part of the diffracted optical component in the intermediate diffractive element is coupled to the second diffractive element substantially between the first and second surfaces so as to allow at least part of the coupled diffracted optical component to exit the substrate by diffraction in the second diffractive element thus providing an output optical beam defined by a further wave-vector k1 having exactly the same direction as the wave-vector k of the input optical beam.

According further to the third aspect of the invention, the intermediate diffractive element may support only reflective zero and first order reflective modes, or an index of refraction of the substrate may be given by n>λ/d, wherein λ is a wavelength of the input optical beam.

Further according to the third aspect of the invention, a predetermined condition may be maintained, the condition is that a second or higher order modes may be unsupported by the intermediate diffractive element, or the condition may be expressed as

$$\sqrt{1 + 8 {cos}^{2} ρ} > \frac{nd}{λ} ,$$

wherein n is an index of refraction of the substrate, λ is a wavelength of the input optical beam. Further, ρ may be given by 0<ρ<70°.

Still further according to the third aspect of the invention, another predetermined condition may be maintained, the condition is that transmission modes may be unsupported for the intermediate diffractive element, or the condition may be expressed as λ/d>1, wherein λ is a wavelength of the input optical beam.

According yet further to the third aspect of the invention, the electronic device may be a digital camera, a computer game device, a wireless device, a portable device or a mobile terminal.

According still further to the third aspect of the invention, the electronic device may further comprise a communications unit for receiving signals containing information indicative of the image data, wherein the data processing unit is operatively connected to the communications unit for receiving the information.

### BRIEF DESCRIPTION OF THE DRAWINGS

For a better understanding of the nature and objects of the present invention, reference is made to the following detailed description taken in conjunction with the following drawings, in which:

FIG. 1 is a schematic representation showing a prior art exit pupil extender using three diffractive elements.

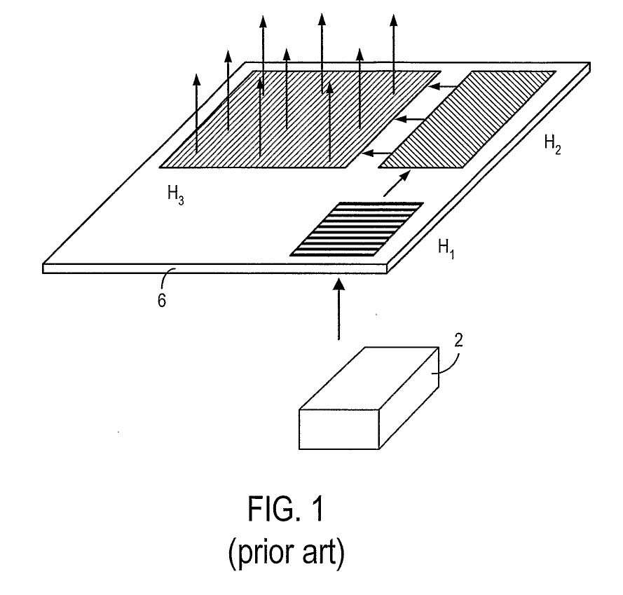

FIG. 2 is a schematic representation showing geometry of a generalized 2D exit pupil expander, according to an embodiment of the present invention.

FIG. 3 is a schematic representation of an embodiment of the present invention showing an electronic device, having a virtual display system.

### MODES FOR CARRYING OUT THE INVENTION

The object of the present invention is to provide a general diffractive optics method that uses a plurality of diffractive elements on an optical substrate for expanding the exit pupil of a display of an electronic device for viewing. The general diffractive optics method of the present invention can be applied to a broad optical spectral range of optical beams but most importantly to a visible part of the of optical spectrum where the optical beams are called light beams.

According to an embodiment of the present invention, this method can be used for optical coupling in an optical device and it is characterized by expanding of an exit pupil of an input optical (e.g., light) beam provided in an output optical (e.g., light) beam, wherein the optical device comprises: a substrate of optical material (or an optical substrate) having a first surface and an opposing second surface; a first (in-coupling) diffractive element disposed on the substrate for receiving an input optical beam defined by a wave-vector k and containing periodic lines with a period d; a second (out-coupling) diffractive element disposed on the substrate in relationship with the first diffractive element and containing further periodic lines with the period d, wherein an angle between the periodic lines and the further periodic lines is 2ρ; and an intermediate (expanding) diffractive element disposed adjacent to the first and the second diffractive elements.

Furthermore, at least part of the received optical beam is diffracted in the first diffractive element for providing a diffracted optical component to the intermediate diffractive element substantially within the first and second surfaces (e.g., undergoing a total internal reflection). Moreover, at least part of the diffracted optical component in the intermediate diffractive element is coupled to the second diffractive element substantially between the first and second surfaces (again, e.g., undergoing a total internal reflection) so as to allow at least part of the coupled diffracted optical component to exit the substrate by diffraction in the second diffractive element thus providing an output optical beam defined by a further wave-vector k1. Typically, the second diffractive element generates also another output beam, which wave-vector is a mirror image of the wave vector k1 with respect to the substrate surface. As this wave vector is otherwise identical to the wave vector k1 and in real applications it is intentionally damped to a low value, therefore it is not be considered further separately from the wave vector k1.

According to an embodiment of the present invention, the intermediate diffraction grating contains still further periodic lines with an angle (or a rotation angle) between the periodic lines of the first diffractive element and the still further periodic lines of ρ, and the period d′ of the still further periodic lines is given by

d′=d/2 cos ρ (1).

Furthermore, according to an embodiment of the present invention, when the period of the intermediate diffractive element is set to d/2 cos ρ(Equation 1), the further wave-vector k1 has exactly the same direction as the wave-vector k of said input optical beam, i.e., the system is geometrically accurate.

According to an embodiment of the present invention, a optical component is incident and diffracted to a first order on the intermediate diffraction element an uneven number of times before providing said at least part of the diffracted optical component to the second diffraction element. Moreover, according to an embodiment of the present invention, the first diffractive element, the second diffractive element or the intermediate diffractive element can be disposed on the first surface or on the second surface of the optical substrate. Furthermore, according to an embodiment of the present invention, the first diffractive element, the second diffractive element or the intermediate diffractive element can be a planar diffraction grating manufactured using lithographic methods or classically ruled (having different groove angles and profiles, such as binary, triangular, sinusoidal, etc.).

The generalized method, according to the present invention provides conditions for supporting a broad variety of rotation angles ρ such that the system is geometrically accurate (i.e., wave-vectors k and k1 has the same direction). The period of the first diffractive element is such that it supports only zero and first order transmissive diffraction modes, which are used to couple the light into the substrate. It is shown below that if the intermediate diffractive element supports only the zero and first order reflective modes and other modes are forbidden, then the system can support a broad range of rotation angles 0<ρ<70°. That means that a broad range of conical incident angles (at least between 0 and 70° and beyond) can be supported by the intermediate diffractive element (the conical angle is an angle between the plane of an incident beam and a plane perpendicular to the periodic lines).

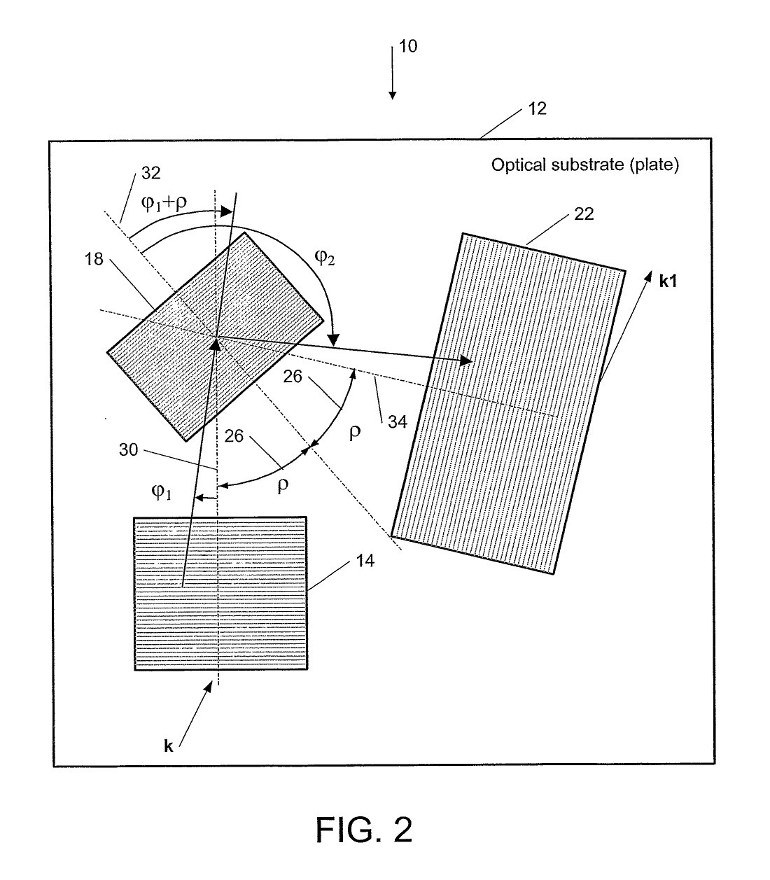

FIG. 2 shows one example among others of a schematic representation for geometry of a generalized two-dimensional (2D) exit pupil expander (EPE) 10, according to the present invention. Figure illustrates the general diffractive optics method described above.

FIG. 2 shows a top view of an optical substrate (plate) 12 having index of refraction n with three diffractive elements disposed on the optical substrate 12: the first (in-coupling) diffractive element (an in-coupling diffraction grating) 14 having the line period d, the intermediate (expanding) diffracting element (an intermediate diffraction grating) 18 having the line period d′ given by the Equation 1 and the second diffractive element (an out-coupling diffraction grating) 22 having the line period d. The line periods d and d are chosen such that appropriate conditions are satisfied for a total internal reflection in the optical substrate (waveguide) 12. Typically, the grating 14 supports transmissive modes of orders 0, −1 and +1 and a reflective zero order. The grating 18 supports reflective modes of orders 0, −1, and the grating 22 supports reflective modes of orders 0, −1 and −2 and the transmissive modes of orders −1 in the case of +1 transmissive coupling in the in-coupling grating. If we choose −1 mode in the in-coupling, the signs of the modes change. Physically both cases are identical, and it is enough to consider only the +1 in-coupling case. The rotation angle ρ 26 marks the orientation of the intermediate diffraction grating 18 with respect to the in-coupling diffraction grating 14. The input optical beam entering the in-coupling diffraction grating 14 is described by a wave-vector k which has component angles (θ₀,φ₀) which are formed with a coordinate axis 30 and an axis perpendicular to the surface of the optical substrate 12, respectively. After propagating through, the optical beam inside the optical substrate 12 with respect to the intermediate diffraction grating 18 has the component angles (θ₁,φ₁+ρ) which are formed with a coordinate axis 32 and the axis perpendicular to the surface of the optical substrate 12, respectively, wherein

$$\{ \begin{matrix}n sin {θ}_{1} sin {ϕ}_{1} = sin {θ}_{0} sin {ϕ}_{0} = γ \\ n sin {θ}_{1} cos {ϕ}_{1} = sin {θ}_{0} cos {ϕ}_{0} + \frac{λ}{d} = {α}_{0} + \frac{λ}{d} .\end{matrix} \qquad ( 2 )$$

In Equation 2 the +1 diffraction mode in chosen in the in-coupling diffraction grating 14. After the intermediate diffraction grating 18, the optical beam is described by angles (θ₂,φ₂), which are formed with a coordinate axis 34 and the axis perpendicular to the surface of the optical substrate 12, respectively, and which are governed by equations

$$\{ \begin{matrix}n sin {θ}_{2} sin {ϕ}_{2} = n sin {θ}_{1} sin ( {ϕ}_{1} + ρ ) = γcos ρ + {α}_{0} sin ρ \\ \begin{matrix}n sin {θ}_{2} cos {ϕ}_{2} = n sin {θ}_{1} cos ( {ϕ}_{1} + ρ ) + m \frac{λ}{d} 2 cos ρ \\ = {α}_{0} cos ρ - γ sin ρ + ( 2 m + 1 ) \frac{λ}{d} cos ρ .\end{matrix}\end{matrix} \qquad ( 3 )$$

It is noted that the diffraction mode for the intermediate diffraction grating 18 must be m=−1. Now the out-coupling diffraction grating 22 has to be rotated by an angle ρ 26 with respect to the intermediate diffraction grating 18, in order to preserve the angles (the original direction of the input optical beam). The angles of the diffraction mode 1 after the out-coupling diffraction grating 22 are (θ₃,φ₃) and they are defined by equations

$$\{ \begin{matrix}sin {θ}_{3} sin {ϕ}_{3} = n sin {θ}_{2} sin ( {ϕ}_{2} + ρ ) = γcos 2 ρ + {α}_{0} sin 2 ρ \\ sin {θ}_{3} cos {ϕ}_{3} = n sin {θ}_{2} cos ( {ϕ}_{2} + ρ ) + \frac{λ}{d} = {α}_{0} cos 2 ρ - γsin2 ρ .\end{matrix} \qquad ( 4 )$$

Finally, the out-coupled angles must be brought back to the original coordinates. Therefore the coordinates must be rotated by an amount −2ρ. Thus the out-coupled angles (θₒᵤₜ,φₒᵤₜ), which are components of a wave-vector k1 are equal to incoming angles (θ₀,φ₀):

$$\{ \begin{matrix}sin {θ}_{out} sin {ϕ}_{out} = sin {θ}_{3} sin ( {ϕ}_{3} - 2 ρ ) = γ = sin {θ}_{0} sin {ϕ}_{0} \\ sin {θ}_{out} cos {ϕ}_{out} = sin {θ}_{3} cos ( {ϕ}_{3} - 2 ρ ) = {α}_{0} = sin {θ}_{0} cos {ϕ}_{0} .\end{matrix} \qquad ( 5 )$$

and the system is geometrically accurate (i.e., wave-vectors k and k1 has the same direction).

If ρ=0, the period of intermediate diffraction grating 18 is d/2 and we have a reflector that reflects the light back to the direction it came from. This can be used at the end of the plate to circulate the light. The case when ρ=45° gives a period of d/\sqrt{2}, which is a special case of this general 2D exit pupil expander (EPE).

There is another requirement for the grating period. In the intermediate diffraction grating 18 there can be only one reflective diffraction mode (in addition to zero order) and no transmissive modes. From Equation 3 the wave-vector component in the direction perpendicular to the surface of the optical substrate 12 inside the optical substrate 12 can be calculated. We thus get a condition for modes −1 and 0 to exist as described by

$$n > \frac{λ}{d} . \qquad ( 6 )$$

This condition of Equation 6 is valid in all practical cases as far the rotation angle 26 is concerned.

The condition that there are no transmissive modes in the diffraction grating 18 is λ/d>1 and it is valid in all practical cases. Another requirement is that no other reflected modes should exist in the diffraction grating 18. It is enough to consider only the lowest of the diffraction modes, i.e., −2 and +1, and we get accordingly a condition

$$\sqrt{1 + 8 {cos}^{2} ρ} > \frac{nd}{λ} . \qquad ( 7 )$$

This condition described by Equation 7 is typically valid for 0<ρ<70°. That means that a broad range of conical incident angles (at least between 0 and 70° and beyond) can be supported by the intermediate diffraction grating 18 (the conical angle is the angle (φ₁+ρ).

The efficiency of the intermediate diffraction grating 18 reaches very high values at about 60°rotation angle 26 such that the diffraction efficiencies are almost equal for both TE and TM polarizations. Further discussions of ways to improve diffraction efficiencies for both TE and TM polarization modes are provided in the U.S. patent application Ser. No. 11/011,481 “Method and System for Beam Expansion in a Display Device” by T. Levola, filed Dec. 13, 2004.

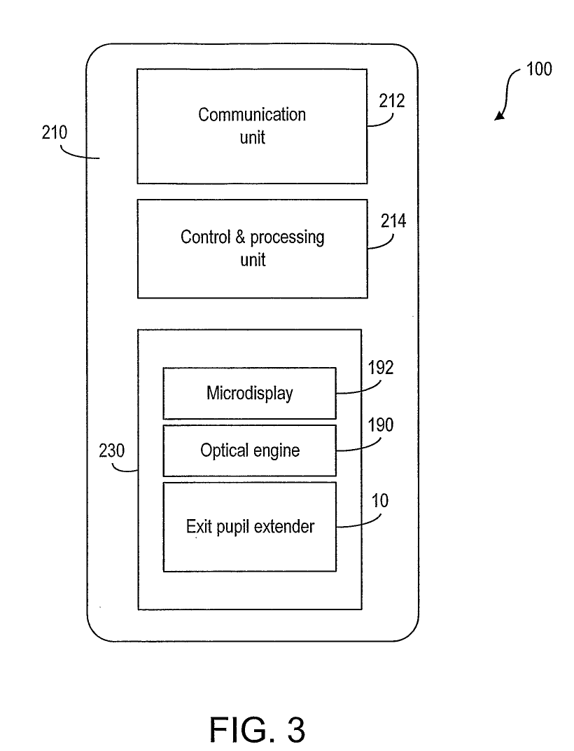

The exit pupil expander (EPE) 10 can be used in an electronic (portable) device 100, such as a mobile phone, personal digital assistant (PDA), communicator, portable Internet appliance, hand-hand computer, digital video and still camera, wearable computer, computer game device, specialized bring-to-the-eye product for viewing and other portable electronic devices. As shown in FIG. 3, the portable device 100 has a housing 210 to house a communication unit 212 for receiving and transmitting information from and to an external device (not shown). The portable device 100 also has a controlling and processing unit 214 for handling the received and transmitted information, and a virtual display system 230 for viewing. The virtual display system 230 includes a micro-display or an image source 192 and an optical engine 190. The controlling and processing unit 214 is operatively connected to the optical engine 190 to provide image data to the image source 192 to display an image thereon. The EPE 10, according to the present invention, can be optically linked to an optical engine 190.

Furthermore, the image source 192, as depicted in FIG. 3, can be a sequential color LCOS (Liquid Crystal On Silicon) device, an OLED (Organic Light Emitting Diode) array, an MEMS (MicroElectro Mechanical System) device or any other suitable micro-display device operating in transmission, reflection or emission.

Moreover, the electronic device 100 can be a portable device, such as a mobile phone, personal digital assistant (PDA), communicator, portable Internet appliance, hand-held computer, digital video and still camera, wearable computer, computer game device, specialized bring-to-the-eye product for viewing and other portable electronic devices. However, the exit pupil expander, according to the present invention, can also be used in a non-portable device, such as a gaming device, vending machine, band-o-matic, and home appliances, such as an oven, microwave oven and other appliances and other non-portable devices.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. An optical device, comprising:
a substrate of optical material having a first surface and an opposing second surface;
a first diffractive element disposed on the substrate for receiving an input optical beam defined by a wave-vector k and containing periodic lines with a period d;
a second diffractive element disposed on the substrate in relationship with the first diffractive element and containing further periodic lines with a period d, wherein an angle between said periodic lines and said further periodic lines is 2ρ; and
an intermediate diffractive element disposed on said substrate adjacent to the first and the second diffractive elements and containing still further periodic lines with the period d/2 cos ρ, wherein ρ is an angle between said periodic lines and the still further periodic lines and said angle ρ is not equal to 45°, wherein
at least part of the input optical beam is diffracted in the first diffractive element for providing a diffracted optical component to the intermediate diffractive element substantially within the first and second surfaces, and
at least part of the diffracted optical component in the intermediate diffractive element is coupled to the second diffractive element substantially between the first and second surfaces so as to allow at least part of the coupled diffracted optical component to exit the substrate by diffraction in the second diffractive element for providing an output optical beam defined by a further wave-vector k1 having exactly the same direction as the wave-vector k of said input optical beam.

2. The optical device of claim 1, wherein said optical device is for extending of an exit pupil of said input optical beam by providing said output optical beam.

3. The optical device of claim 1, wherein said diffracted optical component is incident and subsequently diffracted to a first diffraction order on the intermediate diffractive element an uneven number of times before providing said at least part of the diffracted light component to said second diffractive element.

4. The optical device of claim 1, wherein said intermediate diffractive element supports only reflective zero and first order diffraction modes, or an index of refraction of said substrate is n>λ/d, wherein λ is a wavelength of the input optical beam.

5. The optical device of claim 1, wherein a second or higher order diffraction modes are unsupported by said intermediate diffractive element, which is enforced by a condition expressed as
$$\sqrt{1 + 8 {cos}^{2} ρ} > \frac{nd}{λ} ,$$
wherein n is an index of refraction of said substrate, λ is a wavelength of the input optical beam.

6. The optical device of claim 5, wherein 0<ρ<70°.

7. The optical device of claim 1, wherein a predetermined condition is maintained, said condition is that transmission diffraction modes are unsupported for said intermediate diffractive element, which is enforced by a condition expressed as λ/d>1, wherein λ is a wavelength of the input optical beam.

8. The optical device of claim 1, wherein said first diffractive element, said second diffractive element or said intermediate diffractive element is disposed on said first surface or on said second surface.

9. A method, comprising:
receiving an input optical beam defined by a wave-vector k at a first diffractive element containing periodic lines with a period d and disposed on a substrate of optical material having a first surface and an opposing second surface;
diffracting at least part of the input optical beam in the first diffractive element for providing a diffracted optical component to an intermediate diffractive element substantially within the first and second surfaces;
further diffracting said diffracted optical component by said intermediate diffractive element; and
coupling at least part of said further diffracted said diffracted optical component in the intermediate diffractive element to a second diffractive element substantially between the first and second surfaces so as to allow at least part of the coupled diffracted optical component to exit the substrate by diffraction in the second diffractive element for providing an output optical beam defined by a further wave-vector k1 having exactly the same direction as the wave-vector k of said input optical beam for extending of the exit pupil of an input optical beam, wherein
said second diffractive element is disposed on said substrate in relationship with the first diffractive element and contains further periodic lines with a period d and wherein an angle between said periodic lines and said further periodic lines is 2ρ and
said intermediate diffractive element is disposed adjacent to the first and the second diffractive elements and contains still further periodic lines with the period d/2 cos ρ, wherein ρ is an angle between said periodic lines and the still further periodic lines and said angle ρ is not equal to 45°.

10. The method of claim 9, wherein said diffracted optical component is incident and subsequently diffracted to a first diffraction order on the intermediate diffractive element an uneven number of times before said at least part of the diffracted light component is provided to said second diffractive element.

11. The method of claim 9, wherein said intermediate diffractive element is configured to support only zero and first order reflective diffraction modes, or an index of refraction of said substrate is n>λ/d, wherein λ is a wavelength of the input optical beam.

12. The method of claim 9, wherein the intermediate diffractive element is configured not to support a second or higher order diffraction modes, which is enforced by a condition expressed as
$$\sqrt{1 + 8 {cos}^{2} ρ} > \frac{nd}{λ} ,$$
wherein n is an index of refraction of said substrate, λ is a wavelength of the input optical beam.

13. The method of claim 12, wherein 0<ρ<70°.

14. The method of claim 9, wherein the intermediate diffractive element is configured not to support transmission diffraction modes, which is enforced by a condition expressed as λ/d>1, wherein λ is a wavelength of the input optical beam.

15. The method of claim 9, wherein said first diffractive element, said second diffractive element or said intermediate diffractive element is disposed on said first surface or on said second surface.

16. An electronic device, comprising:
a data processing unit;
an optical engine operatively connected to the data processing unit for receiving image data from the data processing unit;
a display device operatively connected to the optical engine for forming an image based on the image data; and
an exit pupil expander comprising:
a substrate of optical material having a first surface and an opposing second surface;
a first diffractive element disposed on the substrate for receiving an input optical beam defined by a wave-vector k and containing periodic lines with a period d;
a second diffractive element disposed on the substrate in relationship with the first diffractive element and containing further periodic lines with a period d, wherein an angle between said periodic lines and said further periodic lines is 2ρ; and
an intermediate diffractive element disposed on said substrate adjacent to the first and the second diffractive elements and containing still further periodic lines with the period d/2 cos ρ, wherein ρ is an angle between said periodic lines and the still further periodic lines and said angle ρ is not equal to 45°, wherein
at least part of the input optical beam is diffracted in the first diffractive element for providing a diffracted optical component to the intermediate diffractive element substantially within the first and second surfaces, and
at least part of the diffracted optical component in the intermediate diffractive element is coupled to the second diffractive element substantially between the first and second surfaces so as to allow at least part of the coupled diffracted optical component to exit the substrate by diffraction in the second diffractive element for providing an output optical beam defined by a further wave-vector k1 having exactly the same direction as the wave-vector k of said input optical beam.

17. The electronic device of claim 16, wherein said intermediate diffractive element is configured to support only reflective zero and first order reflective diffraction modes, or an index of refraction of said substrate is n>λ/d, wherein λ is a wavelength of the input optical beam.

18. The electronic device of claim 16, wherein the intermediate diffractive element is configured not to support a second or higher order diffraction modes, which is enforced by a condition expressed as
$$\sqrt{1 + 8 {cos}^{2} ρ} > \frac{nd}{λ} ,$$
wherein n is an index of refraction of said substrate, λ is a wavelength of the input optical beam.

19. The electronic device of claim 18, wherein 0<ρ<70°.

20. The electronic device of claim 16, wherein the intermediate diffractive element is configured not to support transmission diffraction modes, which is enforced by a condition expressed as λ/d>1, wherein λ is a wavelength of the input optical beam.

21. The electronic device of claim 16, wherein said electronic device is a digital camera, a computer game device, a wireless device, a portable device or a mobile terminal.

22. The electronic device of claim 16, further comprising a communications unit for receiving signals containing information indicative of the image data, wherein the data processing unit is operatively connected to the communications unit for receiving the information.
